(19) United States
(12) Patent Application Publication
(10) Pub. No.: US 2005/0159156 A1
(43) Pub. Date: Jul. 21, 2005

(54) Controlling communication sessions in a communication system

(75) Inventors: Gabor Bajko, Budapest (HU); Jaro Gabor, Budapest (HU); Petteri Yla Outinen, Ojakkala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/834,992

(22) Filed: Apr. 30, 2004

(30) Foreign Application Priority Data
Jan. 15, 2004 (GB) 0400883.5

(51) Int. Cl. H04Q 7/20

(52) U.S. Cl. 455/435.1; 455/450

(57) ABSTRACT

In a method in a communication system a request for registration of a user equipment to a data network is sent from a second controller to a serving controller. Information regarding the state of the second controller is sent from the second controller to the serving controller.

### BACKGROUND OF THE INVENTION

1. Field of the Invention

The present invention relates to communication systems, and in particular, to control of communication sessions in a system wherein at least one proxy controller entity may be used when providing a user equipment with communication resources.

2. Description of the Related Art

A communication system can be seen as a facility that enables communication sessions between two or more entities such as user equipment and/or other nodes associated with the communication system. The communication may comprise, for example, communication of voice, data, multimedia and so on. A user equipment may, for example, be provided with a two-way telephone call or multi-way conference call. A user equipment may also be provided with a connection to an application providing entity, for example to an application server (AS), thus enabling use of services provided by the application server.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems proving wireless communication for user equipment are known. An example of the wireless systems is the public land mobile network (PLMN). Another example is a mobile communication system that is based, at least partially, on use of communication satellites. Wireless communications may also be provided by means of other arrangements, such as by means of wireless local area networks (WLAN). Communication on the wireless interface between the user equipment and the elements of the communication network can be based on an appropriate communication protocol. The operation of the station apparatus of the communication system and other apparatus required for the communication can be controlled by one or several control entities. The various control entities may be interconnected. One or more gateway nodes may also be provided for connecting a communication network to other networks. For example, a mobile network may be connected to communication networks such as an IP (Internet Protocol) and/or other packet switched data networks.

An example of the services that may be offered for users of a communication system is the so called multimedia services. An example of the communication systems enabled to offer multimedia services is the Internet Protocol (IP) Multimedia network. IP Multimedia (IM) functionalities can be provided by means of a IP Multimedia Core Network (CN) subsystem, or briefly IP Multimedia subsystem (IMS). The IMS includes various network entities for the provision of the multimedia services.

The Third Generation Partnership Project (3GPP) has defined use of the General Packet Radio Service (GPRS) as a backbone communication system for the provision of the IMS services, the GPRS being given herein as a non-limiting example of a possible backbone communication system enabling the multimedia services. The Third Generation Partnership Project (3GPP) has also defined a reference architecture for the third generation (3G) core network which will provide the users of user equipment with access to the multimedia services. This core network is divided into three principal domains. These are the Circuit Switched (CS) domain, the Packet Switched (PS) domain and the Internet Protocol Multimedia (IM) domain.

The latter of these, the IM domain, is for ensuring that multimedia services are adequately managed. The 3G IM domain supports the Session Initiation Protocol (SIP) as developed by the Internet Engineering Task Force (IETF). Session Initiation Protocol (SIP) is an application-layer control protocol for creating, modifying and terminating sessions with one or more participants (endpoints).

Before a user equipment is able to communicate with an IM CN subsystem, a GPRS attach procedure must be performed and a communication channel known as Packet Data Protocol (PDP) context for SIP signalling must be established. The PDP context is established towards the GGSN in the home or visited network. The PDP context will provide the user equipment with an appropriate IP address. This address may then serve as the host address for the duration of the PDP context. The PDP context where the SIP signalling is performed must be available as long as services from the IM CN subsystem are wanted. This requirement is not limited to GPRS access and PDP contexts, but may apply also to other types of access systems and communication channels.

The communication systems have developed in the direction wherein various functions of the network are handled by appropriate controller entities. A user may access services via a data network via a chain of controllers. These controllers are typically provided by means of servers. IMS specifications define different kinds of SIP servers via which services may be accessed. These controllers provide functions such as the call session control functions (CSCFs). It shall be appreciated that the CSCFs may be also referenced to as the call state control functions.

The call session functions may be divided into various categories such as a proxy call session control function (P-CSCF), interrogating call session control function (I-CSCF), and serving call session control function (S-CSCF). The user needs to be registered at the serving call session control function (S-CSCF) in order to be able to request for a service from the communication system. A proxy call session control function (P-CSCF) in turn, is for proxying communications between a user and a serving call session control function (S-CSCF) the user is registered with. In other words, after registration to an IMS data network a user has an outbound proxy (typically a P-CSCF) and a registrar (S-CSCF) assigned. Any activity of the user goes through these data network controller entities.

The S-CSCF has the possibility to deregister the user and send a notification about this to the user. In the notification the S-CSCF can give a hint what the user could do next. For example, the S-CSCF may advise the user to perform an automatic re-registration or just to acknowledge and do nothing. If the S-CSCF is down and the user performs a re-registration, it may be assigned with a new S-CSCF. Even though the user had to terminate all ongoing dialogs with the old serving controller, it can reinitiate them with the new one.

However, a proxy controller, for example a P-CSCF does not have this possibility. In some cases, like in the case of a failure or a software upgrade, a proxy controller may have be shut down. All users connected to the home network via that proxy controller may then experience service discontinuity and may not be able to communicate any more. The communication may be continued only by restarting the user equipment. This is required since the data carrier, for example a PDP context, has been dropped, and needs to be re-established. A problem is that users may not be aware that the proxy controller has been or will be shut down, and therefore cannot decide to initiate any recovery procedures.

There are various reasons why communications between a user equipment and an IMS network may fail. For example, a user equipment may be out of access network coverage, the access network may fail, a proxy server may fail, a physical link may fail, and so on. Restart of the user equipment may not help to recover from a failure. Therefore it may not be reasonable to expect the user to restart the user equipment every time communication fails.

### SUMMARY OF THE INVENTION

Embodiments of the present invention aim to address one or several of the above problems.

According to one embodiment of the present invention, there is provided a method in a communication system. In the method a request for registration of a user equipment to a data network is sent from a second controller to a serving controller and information regarding the state of the second controller is sent from the second controller to the serving controller.

According to another embodiment there is provided a communication system comprising a serving controller configured to accept registrations of at least one user equipment and a second controller for proxying communications between the at least one user equipment and the serving controller. The second controller is configured to signal information to the serving controller regarding the state thereof.

According to yet another embodiment there is provided a proxy controller for a communication system. The proxy controller is configured to forward registrations of user equipments to a serving controller, and to signal information to serving controllers regarding the state thereof.

Embodiments may provide a way of avoiding discontinuity in the communication between a user equipment and a application server. The user perception may be improved since the user does not necessarily notice any temporary failures. Neither may the user be required to intervene to re-establish communications with the network should a failure occur in a proxy controller entity.

### BRIEF DESCRIPTION OF THE DRAWINGS

For better understanding of the present invention, reference will now be made by way of example to the accompanying drawings in which:

FIG. 1 shows a communication system environment wherein the invention can be embodied;

FIG. 2 is a flowchart illustrating the operation of one embodiment of the invention;

FIG. 3 shows a messaging flow in accordance with an embodiment of the invention; and

FIG. 4 shows a messaging flow for operation following an event in a controller.

### DETAILED DESCRIPTION OF THE PREFERRED EMBODIMENTS

Certain embodiments of the present invention will be described in the following by way of example, with reference to the exemplifying architecture of a third generation (3G) mobile communications system. However, it shall be appreciated that the embodiments may be applied to any suitable communication system.

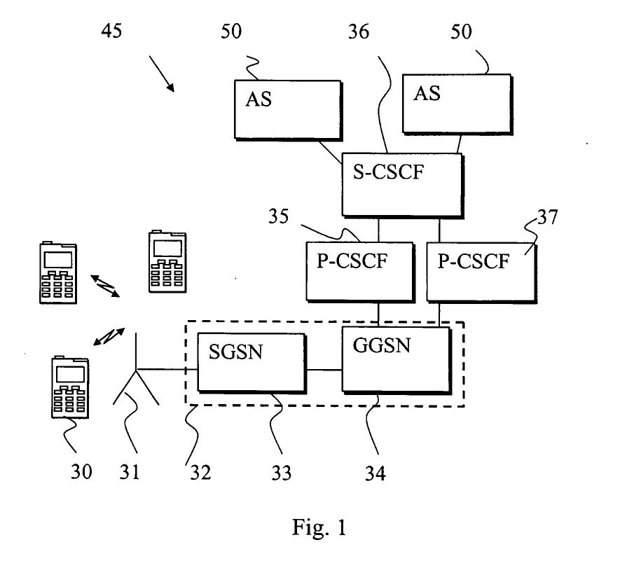

Reference is made to FIG. 1 which shows an example of a network architecture wherein the invention may be embodied. In FIG. 1 an IP Multimedia Network 45 is provided for offering IP multimedia services for IP Multimedia Network subscribers.

As described above, access to IP Multimedia (IM) services can be provided by means of a mobile communication system. A mobile communication system is typically arranged to serve a plurality of mobile user equipment usually via a wireless interface between the user equipment and at least one base station 31 of the communication system. The mobile communication system may logically be divided between a radio access network (RAN) and a core network (CN).

The base station 31 is arranged to transmit signals to and receive signals from a mobile user equipment 30 via a wireless interface between the user equipment and the radio access network. Correspondingly, the mobile user equipment 30 is able to transmit signals to and receive signals from the radio access network via the wireless interface.

In the shown arrangement the user equipment 30 may access the IMS network 45 via the access network associated with the base station 31. It shall be appreciated that, although, for clarity reasons FIG. 1 shows a base station of only one radio access network, a typical communication network system usually includes a number of radio access networks.

The 3G radio access network (RAN) is typically controlled by appropriate radio network controller (RNC). This controller is not shown in order to enhance clarity. A controller may be assigned for each base station or a controller can control a plurality of base stations, for example in the radio access network level. It shall be appreciated that the name, location and number of the radio network controllers depends on the system.

The mobile user equipment 30 of FIG. 1 may comprise any appropriate mobile user equipment adapted for Internet Protocol (IP) communication to connect the network. For example, the mobile user may access the cellular network by means of a Personal computer (PC), Personal Data Assistant (PDA), mobile station (MS) and so on. The following examples are described with reference to mobile stations.

One skilled in the art is familiar with the features and operation of a typical mobile station. Thus, it is sufficient to note that the user may use a mobile station for tasks such as for making and receiving phone calls, for receiving and sending data from and to the network and for experiencing multimedia content or otherwise using multimedia services. A mobile station may include an antenna for wirelessly receiving and transmitting signals from and to base stations of the mobile communication network. A mobile station may also be provided with a display for displaying images and other graphical information for the user of the mobile user equipment. Camera means may be provided for capturing still or video images. Speaker means are also typically provided. The operation of a mobile station may be controlled by means of an appropriate user interface such as control buttons, voice commands and so on. Furthermore, a mobile station is provided with a processor entity and a memory means.

It shall be appreciated that although only few mobile stations are shown in FIG. 1 for clarity, a great number of mobile stations may be in simultaneous communication with a communication system.

A core network (CN) typically includes various switching and other control entities and gateways for enabling the communication via a number of radio access networks and also for interfacing a single communication system with one or more communication system such as with other cellular systems and/or fixed line communication systems. In the 3GPP systems the radio access network is typically connected to an appropriate core network entity or entities such as, but not limited to, a serving general packet radio service support node (SGSN) 33. The radio access network is in communication with the serving GPRS support node via an appropriate interface, for example on an Iu interface. The serving GPRS support node, in turn, typically communicates with an appropriate gateway, for example a gateway GPRS support node 34 via the GPRS backbone network 32. This interface is commonly a switched packet data interface.

In a 3GPP network, a packet data session is established to carry traffic flows over the network. Such a packet data session is often referred as a packet data protocol (PDP) context. A PDP context may include a radio bearer provided between the user equipment and the radio network controller, a radio access bearer provided between the user equipment, the radio network controller and the SGSN 33, and switched packet data channels provided between the serving GPRS service node 33 and the gateway GPRS service node 34. Each PDP context usually provides a communication pathway between a particular user equipment and the gateway GPRS support node and, once established, can typically carry multiple flows. Each flow normally represents, for example, a particular service and/or a media component of a particular service. The PDP context therefore often represents a logical communication pathway for one or more flow across the network. To implement the PDP context between user equipment and the serving GPRS support node, at least one radio access bearer (RAB) needs to be established which commonly allows for data transfer for the user equipment. The implementation of these logical and physical channels is known to those skilled in the art and is therefore not discussed further herein.

FIG. 1 shows also a plurality of application servers 50 connected to the exemplifying Internet Protocol (IP) Multimedia network 45. The user equipment 30 may connect, via the GPRS network 32 and an IMS network 45, to at least one of the application servers 50. It shall be appreciated that a great number of application servers may be connected to a data network.

Communication with the application servers is controlled by means of functions of the data network that are provided by appropriate controller entities. For example, in the current third generation (3G) wireless multimedia network architectures it is assumed that several different servers providing various control functions are used for the control. These include functions such as the call session or call state control functions (CSCFs). The call session functions may be divided into various categories. FIG. 1 shows proxy call session control functions (P-CSCF) 35 and 37 and a serving call session control function (S-CSCF) 36. It shall be appreciated that similar functions may be referred to in different systems with different names.

A user who wishes to use services provided by an application server via the IMS system may need first to register with a serving controller, such as the serving call session control function (S-CSCF) 36. The registration is required to enable the user equipment to request for a service from the multimedia system. As shown in FIG. 1, communication between the S-CSCF 36 and the user equipment 30 may be routed via at least one proxy call session control function (P-CSCF) 35. The proxy CSCF 35 thus acts as a proxy which forwards messages from the GGSN 34 to a serving call session control function 36 and vice versa.

In the embodiments a serving controller is provided with information about the status of the proxy controller. The serving controller may then inform a user equipment accordingly. For example, the serving controller may ask the user equipment to drop the relevant PDP context and to re-establish the PDP context in order for the communication to continue.

To provide this a new event state may be defined for the proxy controller. Examples of possible states include ‘operational’, ‘shut down in progress’, ‘busy’, ‘overloaded’ and so on. The state information may then be provided to the serving controller by means of a respective state indicator.

The status ‘operational’ may be used to tell to the event subscribers that the proxy controller, for example the P-CCSF 35 of FIG. 1, is up and running. The ‘shut down in progress’ status can be used to tell to the event subscribers that the proxy controller is to be shut down. This may be used as an indication to the serving controller that users connected through this proxy should be notified as soon as possible that the users should reregister themselves to the network and thereby obtain a new proxy controller assigned.

Other optional states may also be defined. For example, the above mentioned ‘overloaded’ may be used to indicate that the proxy server is busy in accomplishing the already existing tasks, and cannot take any new load. When the load decreases, the proxy server may inform the serving server that it is again operational and ready to handle communications between the serving server and user equipment. The ‘overload’ indicator or similar may be used for enabling use of the state information for traffic and/or load control.

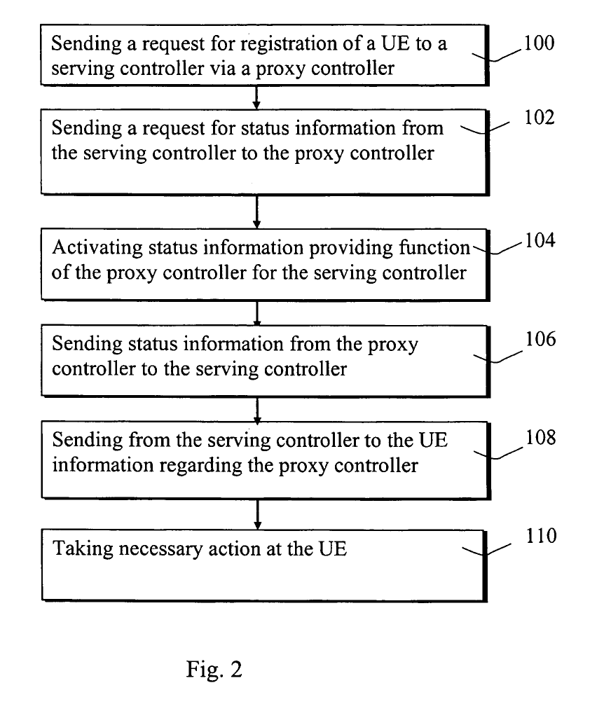

Referring now to FIG. 2. In step 100 a user equipment (UE) may initiate the registration process by sending a message comprising a request for registration to a serving controller, for example to the S-CSCF 36 of FIG. 1, via a second controller entity. After successful registration proceed, the user equipment may communicate in association with the serving controller via the second controller entity.

The serving controller may send at step 102 a message to the second controller requesting the second controller to provide the serving controller with information about the state thereof. Upon receipt of the request, the second controller may register the serving controller to be an entity that shall be provided with state information. It shall be appreciated that it may not always be necessary to send a separate request for the state information. For example, the information providing function may be activated as a default procedure in a second controller proxying communications between a user equipment and a serving controller.

A status information providing function of the second controller is activated at step 104. Information about the status of the second controller may then be delivered at step 106 from the second controller to the serving controller.

The delivery may be triggered for example by a specific event. A such even may be, for example, a change in the state of the second controller. State information may also be sent periodically, or per request by the serving controller.

The serving controller may then use the state information in appropriate manner. For example, the serving controller may send at step 108 instructions to the user equipment that it should seek for a new proxy controller and re-register to the data network.

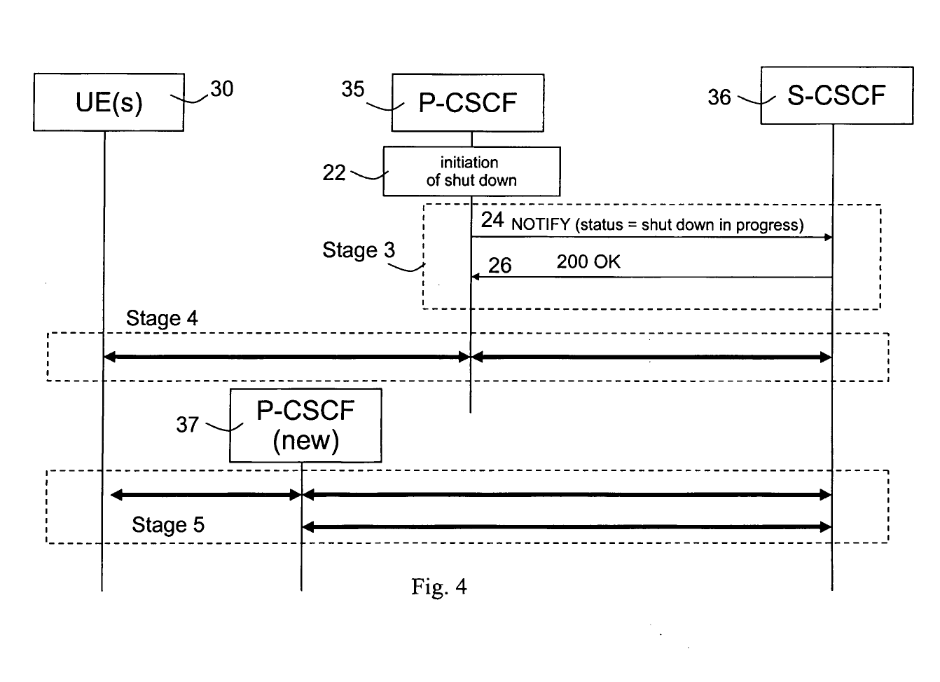

Upon receipt of the information from the serving controller the user equipment may then decide at step 110 to act in an appropriate manner. For example, the user equipment may initiate discovery proceedings and re-registration to another proxy controller. Examples of possible actions will be given below with reference to FIG. 4.

Actions may be taken in response to change of state of a proxy controller without any user interaction. Thus the user of the user equipment may not notice for example a change from a proxy to another.

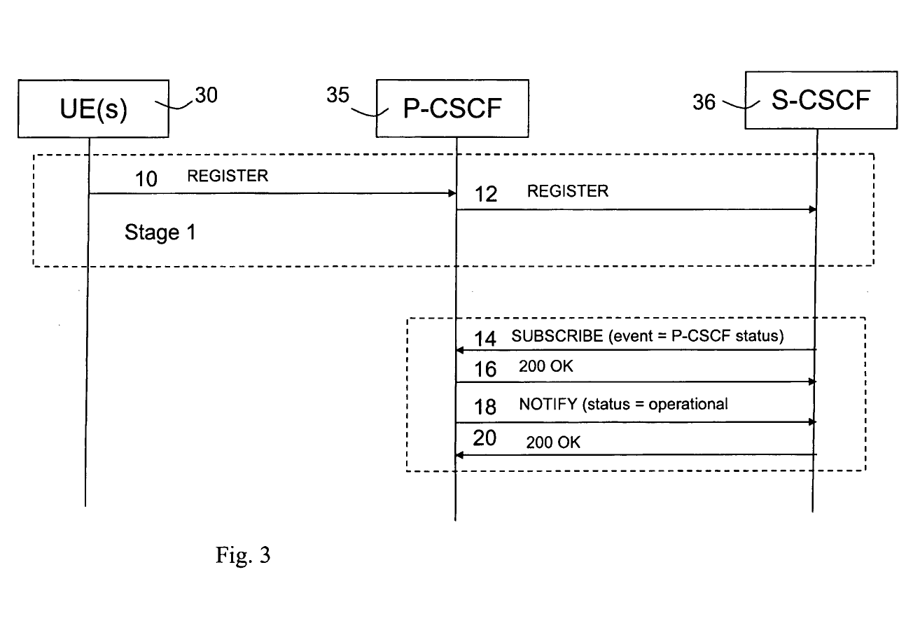

In a preferred embodiment illustrated in FIG. 3 a serving controller subscribes to the state information of a proxy controller after a user equipment has been registered to the serving controller. More particularly, in FIG. 3 a user equipment 30 is shown to be registered at stage 1 with a S-CSCF 36 by means of messages 10 and 12 delivered via a P-CSCF 35 acting as a proxy for the users served by the S-CSCF 36. The S-CSCF 36 may receive the address of the P-CSCF 36 in a path header of message 12. The address may be, for example, an IP address of the P-CSCF 36.

At stage 2 the S-CSCF 36 may then subscribe by message 14 for the status event of the P-CSCF 35. Acknowledgement message 16 may be sent is response to the subscription message 14.

A report that the status event reporting functionality is in operation may also be sent by message 18. The P-CSCF 36 may then acknowledge receipt of message 18 by message 20.

FIG. 4 illustrates operation when the proxy controller, e.g. P-CSCF 35, is going to be shut down. The shut down is initiated at step 22. The serving controller, e.g. the S-CSCF 36, may then receive a notification at stage 3 in accordance with the relevant subscription. The notification is shown to be provided in message 24. The S-CSCF 36 may acknowledge the notification by message 26.

The S-CSCF 36 may then initiate re-registration of all user equipment served by the P-CSCF 35 that is or will be shut down at stage 4. The S-CSCF 36 may also deregister all users connected to the network through the P-CSCF 35. The S-CSCF 36 also preferably send a request to the user equipment 30 that it reregisters itself to the network.

The user equipment 30 may acknowledge the deregistration. The user equipment may then start a P-CSCF discovery procedure and send a new register request to the network. There are various possibilities for the discovery procedure. Two examples are described below.

In the first example the access network is provided by means of a GPRS network. A proxy controller, in this example a Proxy-CSCF, discovery may be performed by means of a mechanism that is based on Dynamic Host Configuration Protocol (DHCP). The DHCP may be used for obtaining address information for any SIP servers, and may thus be used for obtaining appropriate P-CSCF address information, and also appropriate domain name service (DNS) server information, if required. In operation of this example, an appropriate PDP context bearer may first be established by using an appropriate PDP context establishment procedure. The user equipment may then send a request for address information to a DHCP server. The user equipment may request for a list of fully qualified domain names of P-CSCFs and the IP addresses of DNS servers. Alternatively, the user equipment may request for a list of P-CSCF IP addresses. DHCP Query/Response message exchange may be required to retrieve the requested information. DNS Query/Response may then be performed between the user equipment and the DNS server.

If P-CSCF address information is not received in a DHCP response, and the transport protocol and port number are not known to the user equipment, the user equipment may query for the domain returned in the DHCP response to select the transport protocol.

The user equipment may perform a DNS query to retrieve a list of P-CSCF IP addresses from which one is selected. If the response does not contain any IP addresses, an additional DNS query may be needed to resolve a Fully Qualified Domain Name (FQDN) to an IP address. In a response each P-CSCF may be identified by its host domain name. The returned Resource Records (RRs) may be merged and ordered, and an appropriate selection technique may be used to select a P-CSCF. If the response contains the IP address of the selected P-CSCF, a new query to the DNS is not required.

In the second exemplifying discovery mechanism Proxy-CSCF address information is obtained from PDP context activation signalling. In a more particular example, existing GPRS procedures may be used for P-CSCF discovery such that the procedure for establishment of an appropriate PDP context for IM subsystem signalling is used for the discovery purposes. In the first stage of this procedure a PDP context request is sent from the user equipment to a SGSN. The user equipment may indicate in this message that it also wants to have P-CSCF IP address information. The PDP context request is then sent further from the SGSN to an appropriate GGSN. The GGSN is capable of obtaining at least one IP address of at least one P-CSCF. The mechanism to do this is a matter of internal configuration of each network. A PDP Context Response including the address information is then sent from the GGSN to the SGSN. An activate PDP context accept message including the requested address information may then be sent from the SGSN to the user equipment.

The UE can freely decide which mechanisms it will use to acquire P-CSCF address information. If several P-CSCF addresses are provided to a user equipment without any sufficient priority indications, the user equipment may select an address in based on an appropriate criteria. The selection of a P-CSCF address is an implementation specific issue.

After a new proxy server, e.g. P-CSCF 37, has been found and selected, it is assigned for the user equipment. At stage 5 the user equipment may register itself to the up and running P-CSCF 37 and to the S-CSFC 36.

The procedure of transferring from a proxy controller to another may be automatic, and thus user would not necessarily notice the temporary communication failure for non-real time services. For real time services a temporary failure may be noticed. This may occur for example since as ongoing dialogs need to be terminated and reinitiated.

It shall be appreciated that there may be only a few proxy controllers for a number of users. However, only one subscription is needed from a serving controller to the proxy controller even in such case. That is, only one subscription is needed regardless the numbers of users who are registered to the serving controller through that proxy controller.

Proxy controllers may be split into clusters. That is, a physical proxy entity may form a number of logical entities. Each cluster may have a different identity. Thus the clusters of a proxy server may be operated, for example shut down, separately. The operational state change of a part or parts of a cluster is also possible. Clustered arrangements may be employed in certain applications for ensuring continuous communication sessions for users.

The messaging may be based on the session initiation protocol (SIP). SIP was generally developed to allow for initiating a session between two or more endpoints in the Internet by making these endpoints aware of the session semantics. A user connected to a SIP based communication system may communicate with various entities of the communication system based on standardised SIP messages. User equipment or users that run certain applications on the user equipment are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. Examples of the possible sessions include Internet multimedia conferences, Internet telephone calls, and multimedia distribution.

If SIP messaging is used, a user equipment 30 requesting for registration sends a SIP ‘REGISTER’ message via the IMS system to the P-CSCF 35 and then to the S-CSCF 36. The subscription may be sent by means of a SIP ‘SUBSCRIBE’ message. The acknowledgements may be SIP ‘200 OK’ messages. Status reports from P-CSCF to a S-CSCF may be delivered as SIP ‘NOTIFY’ messages.

It should be appreciated that whilst embodiments of the present invention have been described in relation to user equipment such as mobile stations, embodiments of the present invention are applicable to any other type of equipment that needs to be authenticated.

The examples of the invention have been described in the context of an IMS system and GPRS networks. However, this invention is also applicable to any other standards. Furthermore, the given examples are described in the context of the so called all SIP networks with all SIP entities and communication channels known as PDP contexts. This invention is also applicable to any other appropriate communication systems, either wireless or fixed line systems, communication standards and communication protocols.

Examples of other possible communication systems enabling wireless data communication services, without limiting to these, include third generation mobile communication system such as the Universal Mobile Telecommunication System (UMTS), i-phone or CDMA2000 and the Terrestrial Trunked Radio (TETRA) system, the Enhanced Data rate for GSM Evolution (EDGE) mobile data network. Examples of fixed line systems include the diverse broadband techniques providing Internet access for users in different locations, such as at home and offices. Regardless the standards and protocols used for the communication network, the invention can be applied in all communication networks wherein registration in a network entity is required.

The embodiment of the invention have been discussed in the context of proxy and servicing call state control functions. Embodiments of the invention can be applicable to other network elements where applicable.

It is also noted herein that while the above describes exemplifying embodiments of the invention, there are several variations and modifications which may be made to the disclosed solution without departing from the scope of the invention as defined in the appended claims.

1. A method in a communication system, the method comprising:
sending a request for registration of a user equipment to a data network from a second controller to a serving controller; and
sending information regarding the state of a second controller from the second controller to the serving controller.

2. The method as claimed in claim 1, comprising the further step of requesting the second controller to provide the serving controller with information regarding the state of the second controller.

3. The method as claimed in claim 1, comprising the further steps of:
generating instructions for the user equipment based on state information received from the second controller; and
sending the instructions from the serving controller to the user equipment.

4. The method as claimed in claim 3, comprising the further step of initiating by the user equipment at least one action in accordance with the instructions from the serving controller.

5. The method as claimed in claim 4, wherein the step of initiating by the user equipment the at least one action further comprises initiation of re-registration with the data network.

6. The method as claimed in claim 4, wherein the step of initiating by the user equipment the at least one action further comprises initiating a discovery procedure for finding a third controller to replace the second controller.

7. The method as claimed in claim 6, comprising the further steps of:
selecting the third controller;
assigning the third controller for the user equipment; and
continuing communications between the user equipment and the serving controller via the third controller.

8. The method as claimed in claim 4, wherein the step of initiating by the user equipment the at least one action further comprises initiating dropping of a communication channel that has been assigned for the user equipment.

9. The method as claimed in claim 1, comprising the further step of selecting the second controller to comprise a proxy call state control function.

10. The method as claimed in claim 1, comprising the further step of sending at least one message in accordance with a Session Initiation Protocol (SIP).

11. The method as claimed in claim 10, comprising the further step of requesting information regarding the state of the second controller by sending a SIP ‘SUBSCRIBE’ message from the serving controller to the second controller.

12. The method as claimed in claim 10, wherein the step of sending information regarding the state of the second controller to the serving controller comprises sending a SIP ‘NOTIFY’ message.

13. The method as claimed in claim 1, wherein the step of sending information regarding the state of the second controller from the second controller to the serving controller further comprises sending one of an ‘operational’ state, a ‘shut down in progress’ state, a ‘busy’ state, and an ‘overloaded’ state.

14. The method as claimed in claim 3, wherein the step of sending the instructions further comprises sending the instructions to a plurality of user equipment connected via the second controller to the serving controller.

15. The method as claimed in claim 1, wherein the step of sending information regarding the state of the second controller is performed in response to detection of a change in the state of the second controller.

16. The method as claimed in claim 1, further comprising the step of registering the user equipment to a serving controller of an Internet Multimedia Subsystem (IMS).

17. The method as claimed in claim 1, further comprising sending to the serving controller information about an address of the second controller.

18. The method as claimed in claim 1, further comprising the step of sending from the user equipment a request for information regarding controllers of the data network.

19. The method as claimed in claim 1, wherein the step of sending the information regarding the state of the second controller further comprises sending information regarding one cluster of the second controller.

20. A communication system, comprising:
a serving controller configured to accept registrations of at least one user equipment; and
a second controller for proxying communications between the at least one user equipment and the serving controller, the second controller being configured to signal information to the serving controller regarding a state thereof.

21. The communication system as claimed in claim 20, the communication system further comprising an Internet Multimedia Subsystem (IMS).

22. The communication system as claimed in claim 20, wherein the second controller is configured to accept subscriptions for notifications regarding the state thereof.

23. The communication system as claimed in claim 20, wherein the serving controller is configured to generate instructions for the user equipment based on state information received from the second controller.

24. The communication system as claimed in claim 23, wherein the user equipment is configured to initiate at least one action in accordance with the instructions from the serving controller.

25. The communication system as claimed in claim 20, wherein the second controller comprises a proxy server.

26. The communication system as claimed in claim 20, wherein the serving controller comprises a serving call state control function and the second controller comprises a proxy call state control function.

27. A proxy controller for a communication system, the proxy controller being configured to forward registrations of user equipments to a serving controller, and to signal information to serving controllers regarding a state thereof.

28. The proxy controller as claimed in claim 27, wherein the controller is configured to accept subscriptions for notifications regarding the state thereof.

29. A controller for a communication system, the controller being configured to accept registrations of user equipments on requests forwarded thereto via a second controller, to receive and process information regarding a state of the second controller, and to generate and send instructions to user equipments based on information regarding the state of the second controller.

30. The controller as claimed in claim 29, wherein the controller is configured to send a request for information regarding the state of a second controller after the controller has received a request for registration of a user equipment from the second controller.

31. A method in a communication system, comprising:
first sending means for sending a request for registration of a user equipment to a data network from a second controller to a serving controller; and
second sending means for sending information regarding a state of the second controller from the second controller to the serving controller.

32. A communication system, comprising:
first controlling means for accepting registrations of at least one user equipment; and
second controlling means for proxying communications between the at least one user equipment and the first controlling means, the second controlling means being configured to signal information to the first controlling means regarding a state thereof.

33. A proxy controller for a communication system, the proxy controller comprising:
forwarding means for forwarding registrations of user equipments to a serving controller; and
signalling means for signalling information to serving controllers regarding a state thereof.

34. A controller for a communication system, the controller comprising:
accepting means for accepting registrations of user equipments on requests forwarded thereto via a second controller;
receiving means for receiving and processing information regarding a state of the second controller; and
generating means for generating and sending instructions to user equipments based on information regarding the state of the second controller.
